(19) United States
(12) Patent Application Publication
(10) Pub. No.: US 2009/0132423 A1
(43) Pub. Date: May 21, 2009

(54) SEND MONEY PLUG IN FOR WEB MAILS

(75) Inventor: Deborah Yee-Ky Liu, Santa Clara, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/940,403

(22) Filed: Nov. 15, 2007

(51) Int. Cl. G06Q 40/00; H04L 9/32

(52) U.S. Cl. 705/70; 705/35; 705/44

(57) ABSTRACT

In one example embodiment, a system and method is shown as including receiving an email address selection displayed as part of a screen widget, the screen widget included within the display of an interface associated with an Internet-utilizing application. Further, this method may, for example, include executing a plug in having a send money function, the plug in associated with the Internet-utilizing application, the send money function executed due, in part, to a signal received from an input device. The method may additionally include generating a payment request identifying a recipient of funds by the e-mail address selection.

### TECHNICAL FIELD

The present application relates generally to the technical field of transaction algorithms and, in one specific example, the use of a transaction algorithm to verify a payment request.

### BACKGROUND

Persons may be uniquely identified by their e-mail address. This e-mail address may be used as a location at which to receive a communication. This communication may be text based and may contain certain attachments or other vehicles to transmit information. In certain cases, financial information may be communicated.

### BRIEF DESCRIPTION OF THE DRAWINGS

Some example embodiments are illustrated by way of example and not limitation in the figures of the accompanying drawings in which:

FIG. 1 is a diagram of a system used to send funds to the owner of a particular selected e-mail address, according to an example embodiment.

FIG. 2 is an interface for an Internet-utilizing application, which, in this case, is an e-mail client interface, according to an example embodiment.

FIG. 3 is an interface for an Internet-utilizing application which, in this case, is a word processing application interface, according to an example embodiment.

FIG. 4 is an interface for an Internet-utilizing application in the form of a Web browser application interface, according to an example embodiment.

FIG. 5 is a diagram of a transaction information page, according to an example embodiment.

FIG. 6 is a diagram of an interface representing the funds availability and account setup link page, according to an example embodiment.

FIG. 7 is an example login interface that a sender of funds, or recipient of funds may use, according to an example embodiment.

FIG. 8 is a diagram of a payment record page that the sender of funds may see upon the transfer of funds to the particular selected e-mail address, according to an example embodiment.

FIG. 9 is a block diagram of a computer system in the form of a payment processor server, according to an example embodiment.

FIG. 10 is a block diagram of a computer system in the form of one or more devices, according to an example embodiment.

FIG. 11 is a flow chart illustrating a method to generate a payment request, according to an example embodiment.

FIG. 12 is a flow chart illustrating a method used to generate a payment request, according to an example embodiment.

FIG. 13 is a dual stream flowchart illustrating a method used to make a payment request for a particular selected e-mail address, according to an example embodiment.

FIG. 14 is a flow chart illustrating a method used to execute a plug-in engine used to detect a recipient identifier and to generate a selection input, according to an example embodiment.

FIG. 15 is a flow chart illustrating a method used to execute the plug-in engine used to detect a recipient identifier and to generate a selection input from a plurality of recipient identifiers, according to an example embodiment.

FIG. 16 is a flowchart illustrating a method used to execute an operation to format a selection input for transmission, according to an example embodiment.

FIG. 17 is a flowchart describing a method used to execute operation that extracts a recipient identifier from a payment request, according to an example embodiment.

FIG. 18 is a flowchart illustrating a method used to execute an operation that determines whether or not a payment request data is valid, according to an example embodiment.

FIG. 19 is a flowchart illustrating a method used to execute an operation that determines whether or not the payment request data is valid using a sender Internet Protocol (IP) address, according to an example embodiment.

FIG. 20 is a flowchart illustrating a method used to execute an operation that requests sender information, according to an example embodiment.

FIG. 21 is a flowchart illustrating a method used to execute an operation that requests recipient information, according to an example embodiment.

FIG. 22 is a diagram of a recipient account data packet, according to an example embodiment.

FIG. 23 is a flowchart illustrating a method used to execute an operation that determines whether or not funds exist for the transaction to move forward, according to an example embodiment.

FIG. 24 is a flowchart illustrating a method used to execute an operation executed that actually transfers funds to the recipient of funds, according to an example embodiment.

FIG. 25 is an example Relational Data Schema (RDS) that may reside as a part of an account database, according to an example embodiment.

FIG. 26 shows a diagrammatic representation of a machine in the form of a computer system, according to an example embodiment.

### DETAILED DESCRIPTION

Example methods and systems are disclosed to select an e-mail address as it may appear on the Interface for an Internet-utilizing application for the purpose of sending money to this address. In the following description, for purposes of explanation, numerous specific details are set forth to provide a thorough understanding of example embodiments. It will be evident, however, to one skilled in the art that the present invention may be practiced without these specific details.

In some example embodiments, a system and method is illustrated that allows a sender of funds to select an e-mail address, and to send funds to the owner of the e-mail address. A sender of funds may be a user of an Internet-utilizing application who desires to send funds to an owner of an e-mail address. Internet-utilizing applications may include any application (e.g., a Web browser, e-mail client, or Web-based e-mail) that can display executable Web links, in the form of, for example, e-mail addresses. These executable Web links may be executed via the use of some type of input device such as a mouse, light pen, keyboard, or other suitable input device.

Some example embodiments may include, the use of a plug in or other helper application that may be used in conjunction with a Internet-utilizing application. This plug in may utilize technologies including Asynchronous Javascript And eXtensible Markup Language (XML) (collectively referenced as AJAX), Dynamic Hyper Text Markup Language (DHTML), a Java Applet, Java Script, Visual Basic Script, XML, HTML, FLASH™, or some other suitable technology that allows an application to run within the context of another Internet utilizing application. Some example embodiments may include the use of a stand alone application in lieu of a plug in utilizing one or more of the above referenced technologies.

In one example embodiment, the plug in may generate a drop down menu or other suitable screen widget or object that may appear within the display for an Internet utilizing application. This drop down menu may then allow a sender of funds to select a recipient of funds identified through some type of unique identifier such as an email address. The implementation details of this selection process is more fully discussed below.

In one example embodiment, a cursor control device such as a mouse is used to select an e-mail address as it might appear in the interface for an Internet-utilizing application. The selection of this e-mail address may be through, for example, left clicking on the e-mail address (e.g., using the mouse to point to the email address and pressing a left button associated with the mouse). In some example embodiments, a mouse over action may be used to such that when a mouse pointer is placed into close proximity to an email address displayed with the Internet utilizing application, a drop down menu or other suitable screen object or widget will appear. Some other suitable way of putting the focus on the e-mail address may also be used. A right-click function may be used to display a drop-down menu and to select a send money function so as to generate a payment request to be sent over a network.

Some example embodiments may include receiving the payment request at a payment processor server and requesting additional information regarding the payment request. In some example cases, a payment processor server may be operated by a payment processor corporation such as PAYPAL™, VISA™, or MASTERCARD™. Additional information may include the amount of the payment, currency type information, payment purpose information, or other suitable information. Additionally, a determination may be made as to whether the sender of funds and the recipient of funds have an account with the payment processor, and more specifically the payment processor server. In some example embodiments, an account may be a set of data associated with a user, where this set of data uniquely identifies the user and various financial institution accounts that hold money. In certain cases, the recipient of funds may be prompted to set up an account with the payment processor. In other cases, however, the recipient may not be required to set up an account. Part of the set-up process, be it for the sender of funds or the recipient of funds, may be the designation of an account to be linked to by the payment processor account. Specifically, at account set-up time the sender of funds or recipient of funds, may be asked what Financial Institution (FI) accounts (e.g., the account or sender of funds account) are to be linked to, to supply funds to the payment processor account. These linked-to accounts may include checking accounts, saving accounts, debit card accounts, annuity accounts, savings accounts, or some other suitable type account.

In some example cases, once the payment processor accounts of the sender of funds and the recipient of funds are verified, funds may be transferred between a sender-of-funds account and a recipient-of-funds account. For example, funds may be transferred from a sender-of-funds account as it resides on a payment processor server, to a recipient-of-funds account as it resides on a payment processors server. Further, in another example embodiment, funds may be transferred from one FI account held by the sender of funds to another FI account held by the recipient of funds. In one example embodiment, funds may be accessed after a transfer has occurred.

### Example System

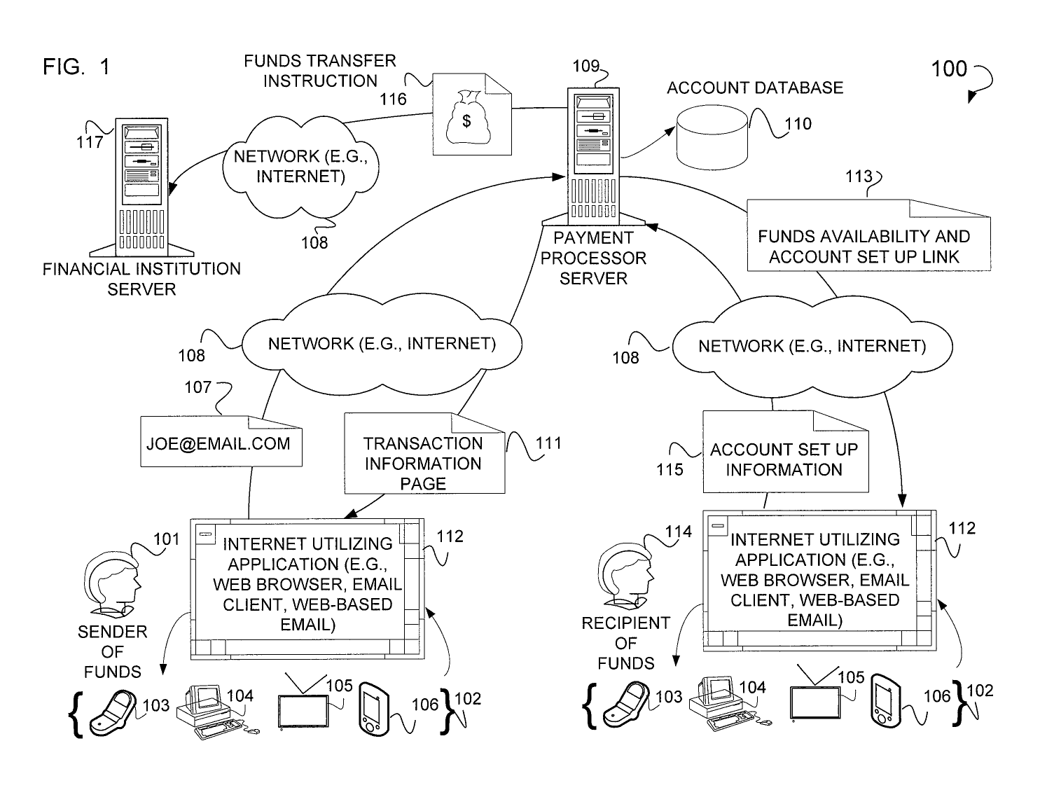

FIG. 1 is a diagram of an example system 100 used to send funds to the owner of a particular selected e-mail address. An owner may be the person in whose name the e-mail address account was opened. A person may be a natural person or a legal entity such as a corporation. Shown is a sender of funds 101 who, using an Internet-utilizing application 112, may select and then send funds via a selected e-mail address. This Internet-utilizing application 112 may reside on, for example, a cell phone 103, a computer system 104, a television 105, a Personal Digital Assistant (PDA) 106, or any other suitable device. Collectively, these various devices (e.g., 103-106) may be referenced as one or more devices 102. Using some type of input device, such as a mouse, light pen, or other suitable device, the sender of funds 101 may select an e-mail address. Once selected, this e-mail address may be sent as a payment request 107 across a network 108 to a payment processor server 109. When the payment request 107 is received at the payment processor 109, the payment processor server 109 may, among other things, look up the account information for the sender of funds 101. This account information may relate to, for example, the particular e-mail address, and associated recipient, that is referenced in the payment request 107. Additionally, this account information may include the amount that is to be sent to the e-mail address and associated recipient, or other suitable information.

In some example embodiments, the payment request 107 may be a data packet used to identify a sender of funds 101 and/or a recipient of funds 114. This payment request 107 may be encoded using any one of a number of network protocols such as, for example, the Transmission Control Protocol/IP (TCP/IP), or some other suitable protocol used to implement the Open Systems Interconnection (OSI) model or TCP/IP protocol stack model. The manner in which the sender of funds 101 and the recipient of funds 114 are identified may include an email address, phone number, or some other suitable way of uniquely identifying an individual.

In some example embodiments, the payment process server 109 may transmit a transaction information page 111 back across the network 108 to be displayed using the Internet utilizing application 112. This transaction information page 111 may, amongst other things, ask or request data relating to the amount to be sent to the particular e-mail address referenced in the payment request 107, and may ask other suitable information. In a further example embodiment, as will be more fully discussed below, cookie data may be retrieved from the Internet-utilizing application 112 such that the transaction information page 111 may be automatically filled in. In some example embodiments, the cookie data may be stored in some type of text based file (e.g., a cookie) containing information relating to, for example, account information for a particular sender of funds.

Some example embodiments may include the payment processor server 109 validating the recipient information and the availability of funds. Specifically, the payment processor server 109 may transmit a funds availability and account setup link page 113 across the network 108 to a recipient of funds 114. The recipient of funds 114 may be a single individual, or a plurality of individuals. Further, these individuals may be identified via a mailing list (e.g., a mail serve list) or other suitable list for identifying individuals utilizing a network. This recipient of funds 114 may use an Internet-utilizing application 112. As previously discussed, this Internet-utilizing application 112 may reside on any one of a number of devices 102. In certain example cases where the recipient of funds 114 does not have an account with the payment processor server 109, the recipient of funds 114 may have to execute an account setup link that is part of the funds availability and account setup link page 113. Once this account setup link is executed via an input device used in conjunction with the Internet-utilizing application 112, account setup information 115 may be transmitted across the network 108 to the payment processor server 109; thus, setting up an account for the recipient of funds 114 on the payment processor server 109. In some example embodiments, funds may be transferred from one account residing on the payment processor server 109 to a second account residing on the payment processor server 109. In other example embodiments, once the recipient of funds 114 sets up an account or already has an account created, the payment processor server 109 may transmit a funds transfer instruction 116 across the network 108 to a financial institution server 117. The financial institution server 117 may then actually transfer funds from the account held by the sender of funds 101 to the second account held by the recipient of funds 114.

### Example Interfaces

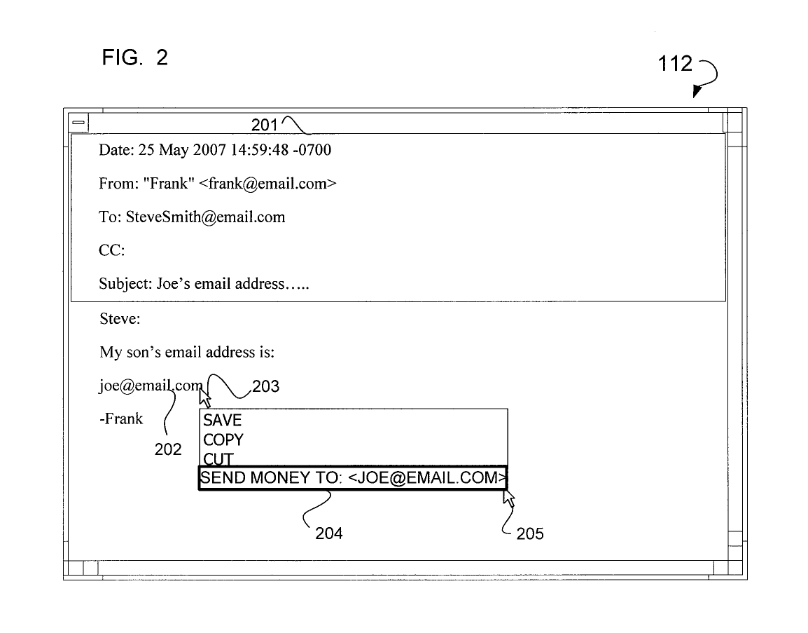

FIG. 2 is a diagram of an interface for the Internet-utilizing application 112, which, in this case, is an e-mail client interface 201. Illustrated is an e-mail client interface 201 displaying a particular e-mail message. Displayed on this e-mail client interface 201, is an e-mail message containing a recipient e-mail address 202 for which the payment request 107 is going to be directed. Some example embodiments may include a sender of funds 101 executing a right-click button using an input device such as a mouse. Once this right-click button is executed, the sender of funds 101 may be further able to execute a send money instruction using an input device such as a mouse. This send money instruction will then be transmitted as, for example, a payment request 107. For example, joe@email.com is the recipient e-mail address 202 that is selected via the execution of a right-click function associated with a right button implemented in a mouse. A mouse pointer may be displayed as a mouse pointer 203 and controlled by the mouse. Once the right-click function is executed, for example, a second position 205 for the mouse pointer 203 is used to execute a send money function 204 as displayed in a drop-down menu. In some example embodiments, the recipient of funds 114 may be identified by their phone number, in addition to, or in place of, their email address as it appears in an internet utilizing application 112. Through using this phone number funds may be transferred from the sender of funds 101 to the recipient of funds 114.

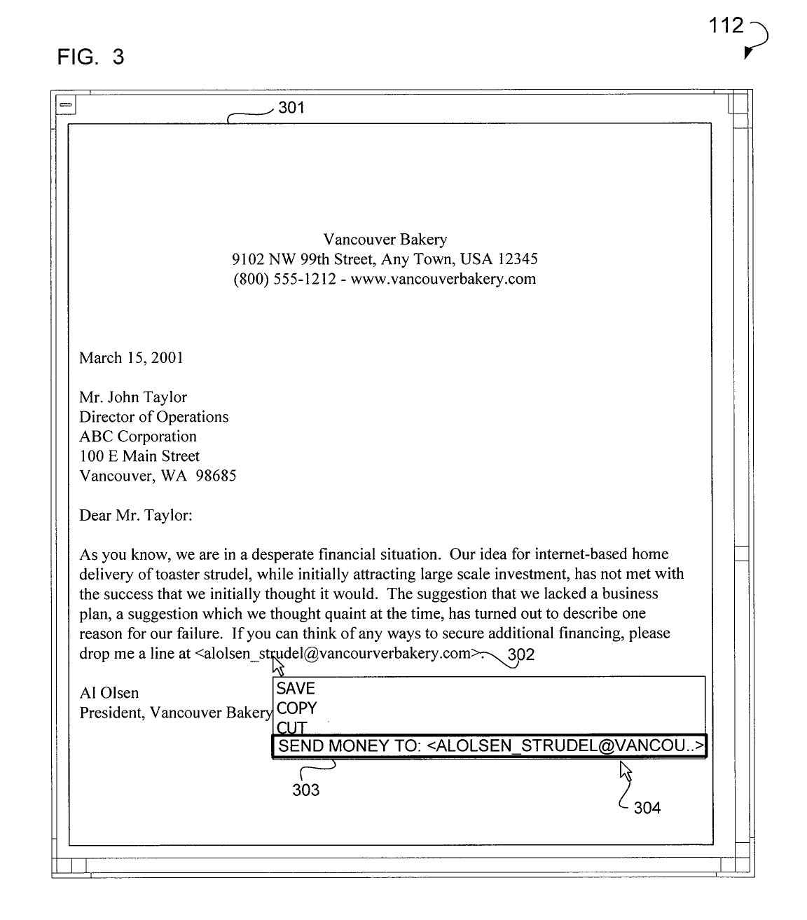

FIG. 3 is a diagram of an interface for the Internet-utilizing application 112 which, in this case, is a word processing application interface 301 with certain types of Internet-based functionality. Illustrated is the word processing application interface 301 displaying an e-mail address 302. Using an input device, such as a mouse and associated mouse pointer, the sender of funds 101 may select the e-mail address 302. By selecting the e-mail address 302, the sender of funds 101 may further execute a right-click function by using the right button on the mouse. Once executed, a drop-down menu may appear that may allow the sender of funds 101 to further use a mouse pointer 304 to select a send money function 303. Here, for example, the send money function 303 is displayed as part of the drop-down menu.

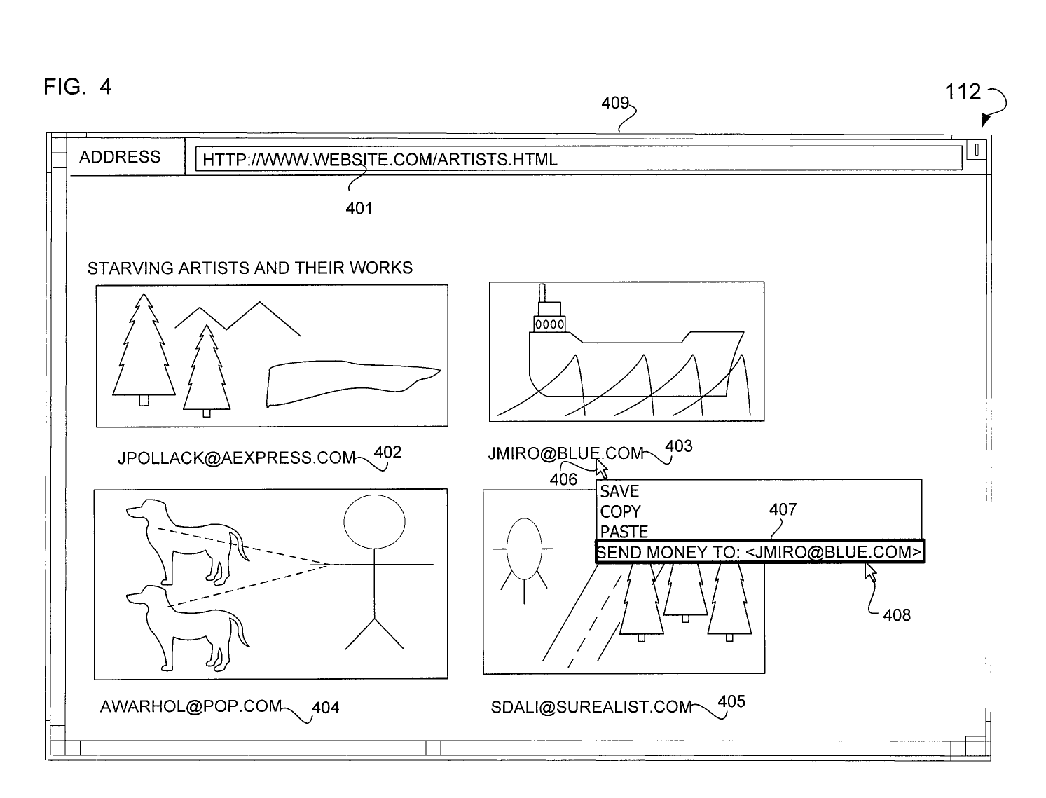

FIG. 4 is a diagram of an example interface for an Internet-utilizing application 112 where this interface is a Web browser application interface 409. Shown is the Web browser application interface 409 that contains a Uniform Resource Locator (URL) textbox 401 for entering a Web address. Once a URL is entered, and the Web address provided, a Hypertext Markup Language (HTML) page may be displayed. Displayed here, for example, is an HTML page with a number of e-mail addresses relating to starving artists and their work. An e-mail address 402 is displayed, an e-mail address 403 is displayed as are e-mail addresses 404 and 405. Shown is the selection of the e-mail address 403 through using a mouse and, in particular, a right-click function associated with the mouse. Mouse pointer 406 shows the execution of the right-click function. Once the right-click function is executed, a second position 408 for the mouse pointer 406 may be used to select a function associated with a drop-down menu displayed as a result of the execution of the right-click function. Here, for example, a send money function 407 has been selected using the second mouse pointer 408 such that the sender of funds 101 may send money to the e-mail address 403, which here is jmiro@blue.com.

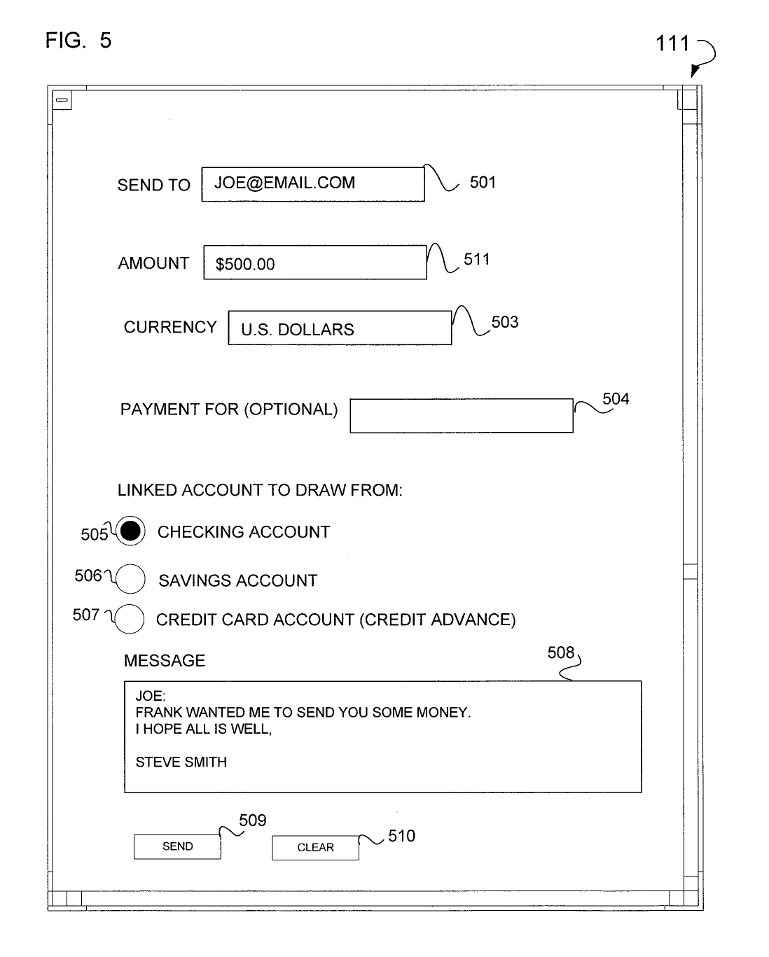

FIG. 5 is a diagram of an example transaction information page 111. Shown is the transaction information page 111 containing various textboxes used to receive data. This transaction information page 111 may be written in, for example, HTML, or some other suitable markup language. In other example cases, this transaction information page 111 may be written as, for example, an interface for a standalone application, written in some suitable programming language such as C++, Java (e.g., a Java Applet), or Visual Basic (e.g., a Visual Basic form). Illustrated is a textbox 501 that requests that the sender of funds 101 provide an e-mail address for the person to whom they want to send funds. In certain instances, this e-mail address may be automatically inserted into the textbox 501 by virtue of the generation of the payment request 107. Further, a textbox 511 is shown that requests that the sender of funds 101 provide an amount of money that they want to send to, for example, the recipient of funds 114. Here, for example, $500 is being sent. Next, a textbox 503 is shown that asks for the type of currency that being sent. Here, for example, US dollars are the currency type. In some example embodiments, other types of currency may be selected such as, for example, Yuan, Euro, Yen, or some other suitable currency type. In some example embodiments, the currency types need not be defined, but rather the currency type is predefined by, for example, the recipient of funds 114. Also shown is a textbox 504 the receives information relating to the purpose of a payment. Here, for example, one may enter that the particular payment is for the satisfaction of a debt owed or some other suitable purpose. Further shown are a number of, for example, radio buttons relating to accounts from which money is to be withdrawn. These accounts would, in some example embodiments, be accounts designated by the sender of funds 101 as accounts from which money is to be drawn by the payment processor server 109. These funds may be withdrawn for satisfaction of, for example, the payment request 107. Shown is a selected radio button 505 relating to a checking account. Also shown is a radio button 506 relating to a savings account, and a further radio button 507 relating to a credit card account. Also, a textbox 508 is provided whereby the sender of funds 101 may provide a message. Here, for example, the sender of funds 101 states “Joe: Frank wanted me to send you some money. I hope all is well, Steve Smith.” Also, certain selection buttons are provided such as, for example, selection button 509 that allows the sender of funds to actually transmit the data provided through the transmission information page 111, or to clear this data via using the clear button 510.

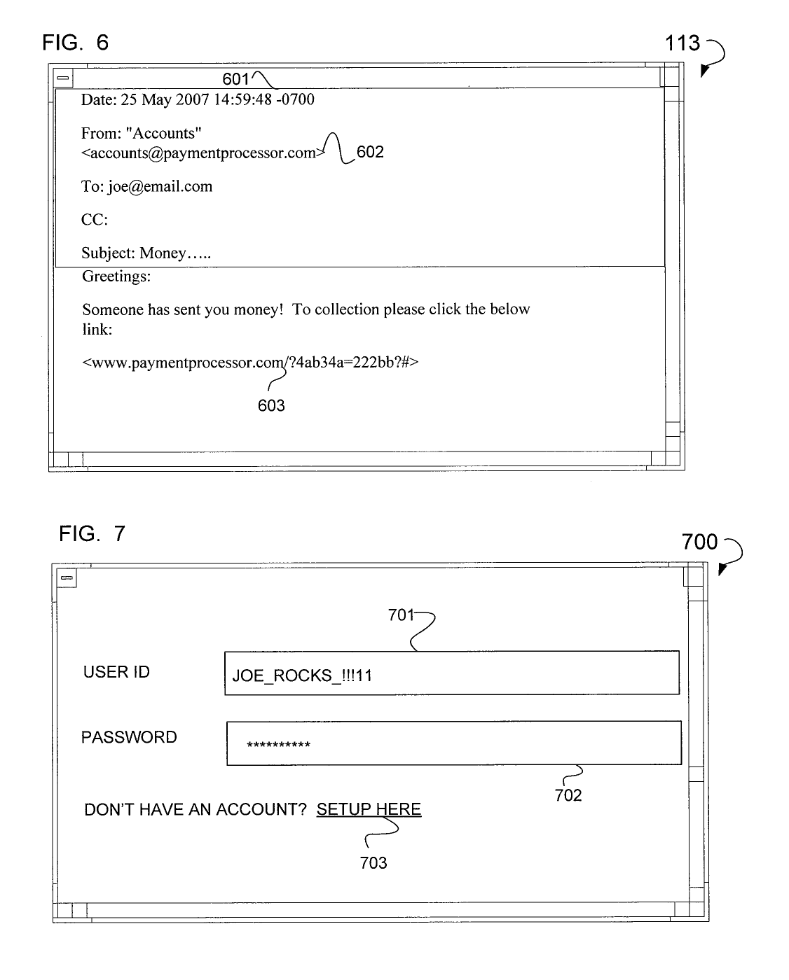

FIG. 6 is a diagram of an interface representing the funds availability and account set-up link page 113. In some example cases, these funds availability and set-up link page 113 may be displayed as part of the interface for an e-mail client 601. This interface for an e-mail client 601 may display, for example, a “from field,” such as from field 602. In some example embodiments, the “from field” displays the e-mail address of the particular payment processor (e.g., the payment processor server 109) that is sending a notification of the availability of funds to the recipient of funds 114. Additionally displayed is an account set-up link 603 that, when executed, allows the recipient of funds 114 to actually set up an account with the payment processor server 109 should they not already have an account. This account set-up process will be more fully discussed below.

FIG. 7 is an example login interface 700 that, for example, a sender of funds 101 or even a recipient of funds 114 may use. Shown is a textbox 701 used to take text in the form of a user ID. Here, for example, “Joe_Rocks_{—}!!!11” has been entered as the user ID. In some example embodiments, a second textbox 702 is shown that takes or requests a password associated with the user ID. As shown, this password is obscured with asterisk values, but could be any type of alpha-numeric based password of some suitable length. Further, an account set-up prompt 703 is shown that allows a party who does not have an account with the payment process server 109 to set up an account by clicking on the account set-up prompt 703.

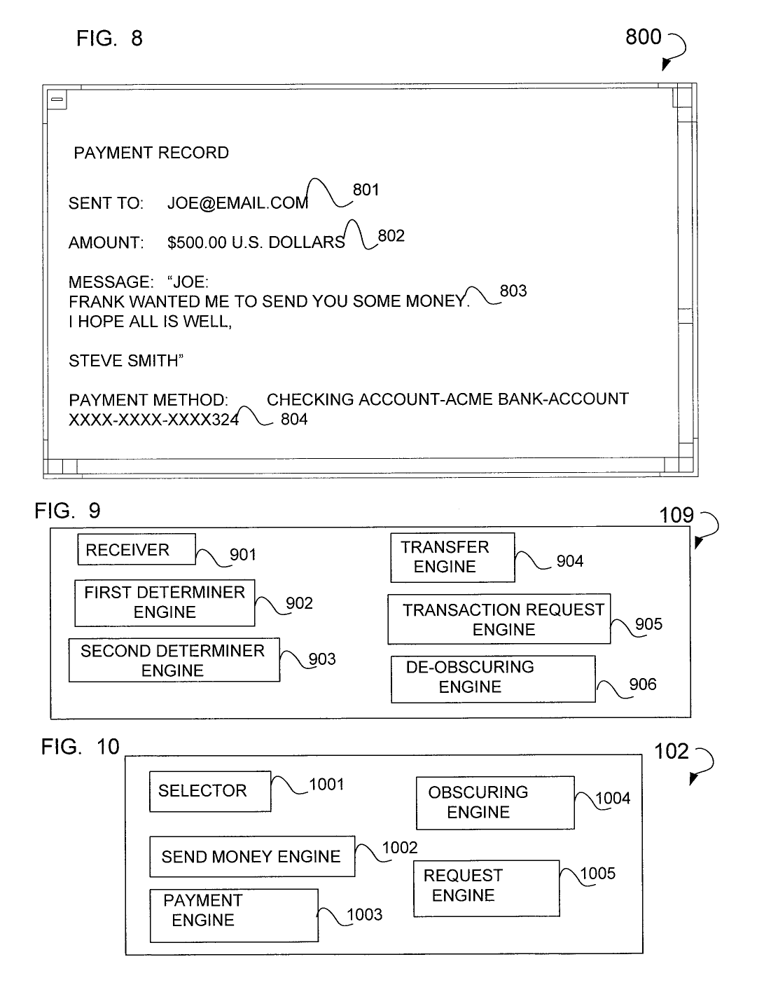

FIG. 8 is a diagram of an example payment record page 800 that the sender of funds 101 may see upon the transfer of funds to the particular selected e-mail address. Shown is a send to field 801 denoting the recipient of funds 114 who here is joe@email.com, and a second amount field 802 stating the monetary amount of the payment and the currency used, which here is $500. A further message field 803 is shown that states a message associated with the payment made to the recipient of funds 114. Further, a payment method field 804 is shown that describes the method of payment or the account it is drawn upon to make the payment to the recipient of funds 114. Here, for example, a checking account, associated with Acme Bank, and a corresponding account number has been provided.

### Example Logic

FIG. 9 is a block diagram of an example computer system in the form of, for example, a payment processor server 109. These various blocks may be implemented in hardware, firmware, or software. Illustrated is a computer system including a receiver 901 to receive a payment request identifying a recipient of funds by an e-mail address. Also shown is a first determiner engine 902 to determine if the recipient of funds has an account and if a sender of funds has an account. A second determiner engine 903 is also shown to determine if funds exist in the sender of funds account to cover a payment request amount. In some example embodiments, cover refers to an amount of funds sufficient to may the requirements of a payment request. In some example cases, the payment request amount is an amount of funds identified by the sender of funds 101 for payment to a recipient of funds 114. A transfer engine 904 is shown to transfer funds to a recipient-of-funds account, where the sender of funds has funds to transfer that cover the payment request amount. In some embodiments, the account is a payment processor account. Some example embodiments may include transferring funds where valid sender transaction data, valid available funds data, and a valid recipient signal are provided. In some example cases, a transaction request engine 905 is shown to request transaction information from the sender of funds, wherein the requested transaction information includes at least one of an amount of currency, a currency type, a payment purpose description, a linked account identifier, and a payment message. Moreover, the transaction information may be stored in as cookie data. Additionally, a de-obscuring engine 906 is shown to de-obscure the payment request using at least one of a symmetric encryption algorithm, an asymmetric encryption algorithm, or a hashing algorithm.

FIG. 10 is a block diagram of an example computer system in the form of, for example, one or more devices 102. These various blocks may be implemented in hardware, firmware, or software. Illustrated is a computer system including a selector 1001 to select an e-mail address as displayed in an interface associated with an Internet-utilizing application using an input device. Also shown is a send money engine 1002 to execute a send money function associated with the Internet-utilizing application, using the input device. Further, a payment engine 1003 is illustrated to generate a payment request identifying a recipient of funds by the e-mail address. In some example embodiments, the input device is a mouse. Some example embodiments may include the Internet-utilizing application including at least one of a Web browser or e-mail client. In some example cases, the selector 1001 selects the send money function through using a right-click function associated with a mouse. An obscuring engine 1004 may obscure the payment request using at least one of a symmetric encryption algorithm, an asymmetric encryption algorithm, or a hashing algorithm. In some example embodiments, a request engine 1005 requests a transaction information page used to designate at least one of an amount of currency, a currency type, a payment purpose description, a linked account identifier, and a payment message.

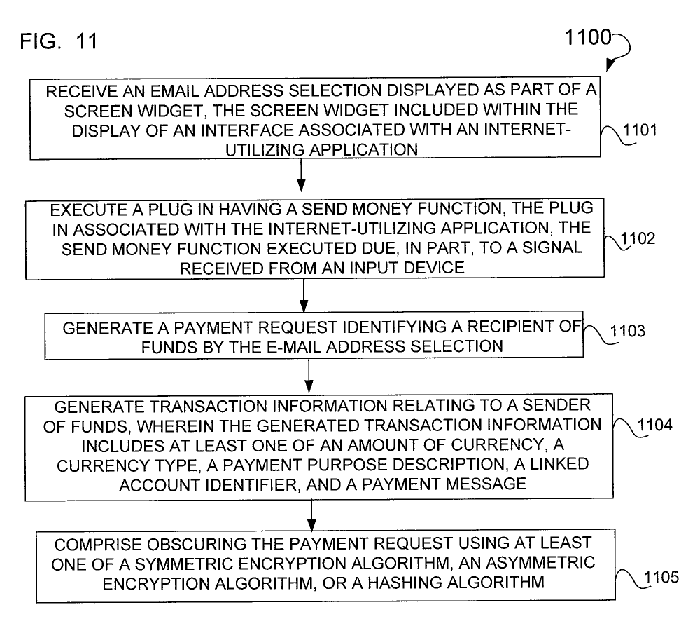

FIG. 11 is a flow chart illustrating a method to generate a payment request, according to an example embodiment. In some example embodiments, illustrated is an operation 1101 that, when executed, receives an email address selection displayed as part of a screen widget, the screen widget included within the display of an interface associated with an Internet-utilizing application. An operation 1102 is then executed that facilitates the execution of a plug in having a send money function, the plug in associated with the Internet-utilizing application, the send money function executed due, in part, to a signal received from an input device. An operation 1103 is executed to generate a payment request identifying a recipient of funds by the e-mail address selection. Operation 1104 is executed to generate transaction information relating to a sender of funds, wherein the generated transaction information includes at least one of an amount of currency, a currency type, a payment purpose description, a linked account identifier, and a payment message. In some example embodiments, the transaction information is stored in a cookie. An operation 1105 is executed to obscure the payment request using at least one of a symmetric encryption algorithm, an asymmetric encryption algorithm, or a hashing algorithm.

In some example embodiments, an operation is executed to receive a payment request identifying a recipient of funds by an e-mail address. Further, an operation is executed to determine if the recipient of funds has an account and a sender of funds has an account. Moreover, an operation is executed to determine if funds exist in the sender of funds account to cover a payment request amount. In some example cases, an operation is executed to transfer funds to a recipient of funds account, where the sender of funds has funds to transfer that cover the payment request amount. The account is a payment processor account, in some example embodiments. Transferring funds may occur where valid sender transaction data, valid available funds data, and a valid recipient signal are provided. Some example embodiments may include executing an operation to request transaction information from the sender of funds, wherein the requested transaction information includes at least one of an amount of currency, a currency type, a payment purpose description, a linked account identifier, and a payment message. The transaction information may be stored in a cookie. In some example embodiments, an operation is executed to de-obscure the payment request using at least one of a symmetric encryption algorithm, an asymmetric encryption algorithm, or a hashing algorithm.

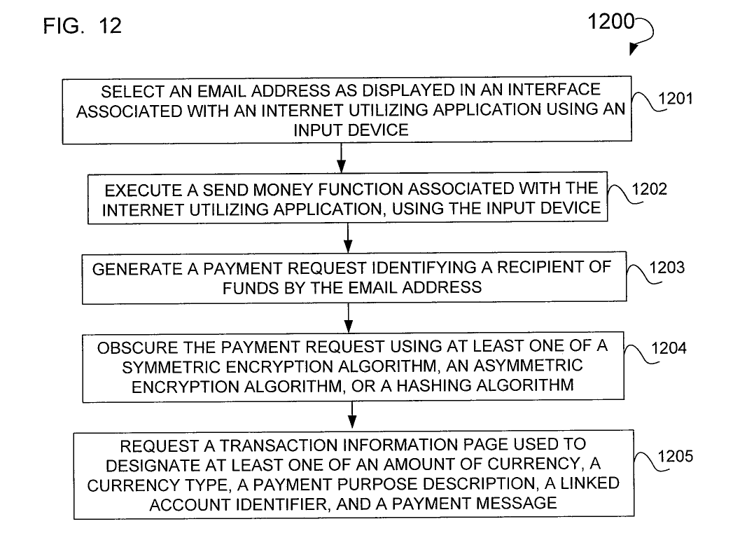

FIG. 12 is a flow chart illustrating an example method used to generate a payment request. Illustrated is an operation 1201 that when executed selects an e-mail address as displayed in an interface associated with an Internet-utilizing application using an input device. An operation 1202 is also shown that when executed, executes a send-money function associated with the Internet-utilizing application, using the input device. Further, an operation 1203 is shown that when executed, generates a payment request identifying a recipient of funds by the e-mail address. The input device may be a mouse. In some example cases, the Internet-utilizing application includes at least one of a Web browser or e-mail client. Some example cases may include executing operation 1201 to select the send money function is performed using a right-click function associated with a mouse. Moreover, some example embodiments may include the execution of an operation 1204 to obscure the payment request using at least one of a symmetric encryption algorithm, an asymmetric encryption algorithm, or a hashing algorithm. Some example embodiments may include executing an operation 1205 to request a transaction information page used to designate at least one of an amount of currency, a currency type, a payment purpose description, a linked account identifier, and a payment message.

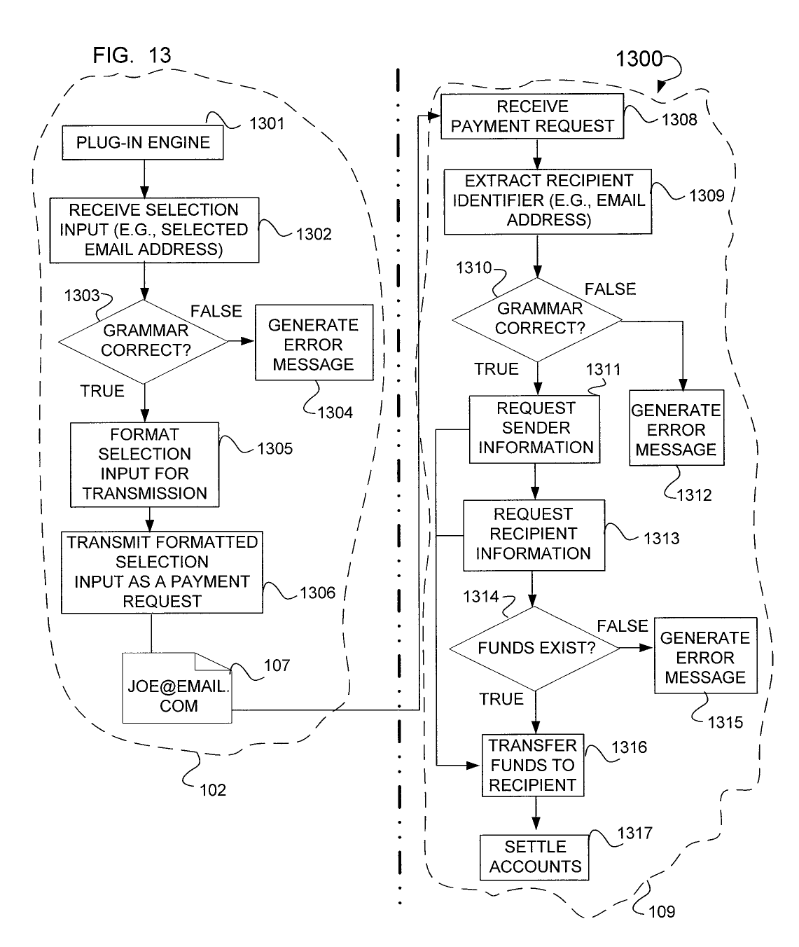

FIG. 13 is a dual stream flowchart illustrating an example method used to make a payment request for a particular selected e-mail address. Shown is a first stream containing modules 1301 through 1306 that may reside as part of, for example, any one of a number of devices 102. In some example embodiments, the various operations 1302 though 1306 may reside as part of the plug in engine 1301, whereas in other embodiments the various operations 1302 through 1306 may reside as part of an Internet-utilizing application. Also illustrated is a second stream containing a number of modules 1308 through 1317 that may reside as a part of, for example, the payment processor server 109.

In some example embodiments, a selection input is generated through the execution of an operation 1301. This selection input may be, for example, input generated, in part, by some type of input/output device such as a mouse, light pen, keyboard, or other suitable input device. Further, when executed, an operation 1302 receives the selection input, which in this case is, for example, an e-mail address. A decisional operation 1303 may be executed to determine whether or not the syntax of the received e-mail address is correct. The correctness of this syntax may be dictated by the requirements of a grammar as defined by, for example, a standards body such as the World Wide Web Consortium (W3C), or as defined in certain Requests for Comments (RFCs). In cases where decisional operation 1303 evaluates to “false,” an operation 1304 is executed that generates an error message that puts, for example, the sender of funds 101 on notice that the e-mail address that they are attempting to send funds to is invalid syntactically. In cases where decisional operation 1303 evaluates to “true,” a further operation 1305 is executed.

This operation 1305 may format the selection input for a transmission, that is, operation 1305 may actually encode, wrap, or otherwise format the selected e-mail address for transmission across the network 108. This formatting may include, for example, the use of the Hyper Text Transfer Protocol Secure (HTTPS), Secure Sockets Layer (SSL), Secure Shell (SSH), and other suitable protocols to obscure the selection input. The HTTPS, SSL, SSH, and other suitable protocols may be used in conjunction with TCP/IP such that a session may be established between, for example, the one or more devices 102 and the payment processor server 109. During the session, a transaction information page 111 may be provided to the sender of finds 101. An operation 1306 may also be executed that transmits the formatted selection input as a payment request, such as payment request 107. The operation 1306, when executed, may apply further link layer and physical layer formatting.

In some example embodiments, the payment request 107 is then transmitted and received through the execution of an operation 1308. An operation 1309 may be executed that extracts a recipient identifier, such as an e-mail address, from the payment request 107. A decisional operation 1310 may be executed to determine whether or not the recipient identifier (e.g., e-mail address) is syntactically correct. In cases where a decisional operation 1310 evaluates to “false,” an operation 1312 is executed that generates an error message. In cases where a decisional operation 1310 evaluates to “true,” a further operation 1311 is executed that requests sender information. This request for sender information will be more fully discussed below, but may include, for example, validating that the sender of funds 101 in fact has an account with the payment processor server 109. Additionally, it may include verifying that funds are available to be sent by the sender of funds 101. Operation 1313 requests recipient information. This operation 1313 may be more fully discussed below, but may include, for example, determining whether or not the recipient of funds 114 has an account with a payment processor server 109, and what financial institution accounts may be linked to this account with the payment processor server 109 and other information. A decisional operation 1314 may be executed that determines whether or not funds exist for the transaction to move forward. In cases where a decisional operation 1314 evaluates to “false,” an operation 1315 may be executed that generates an error message instructing or otherwise informing the sender of funds 101 that sufficient funds do not exist to complete the transaction. In cases where a decisional operation 1314 evaluates to “true,” a further operation 1316 is executed that actually transfers funds to the recipient of funds 114. Operation 1317, in some example embodiments, acts to settle accounts such that the actual transfer of funds from an account held by the sender of funds 101 to an account held by the recipient of funds 114 may be reflected in the balances for each of the respective account holders.

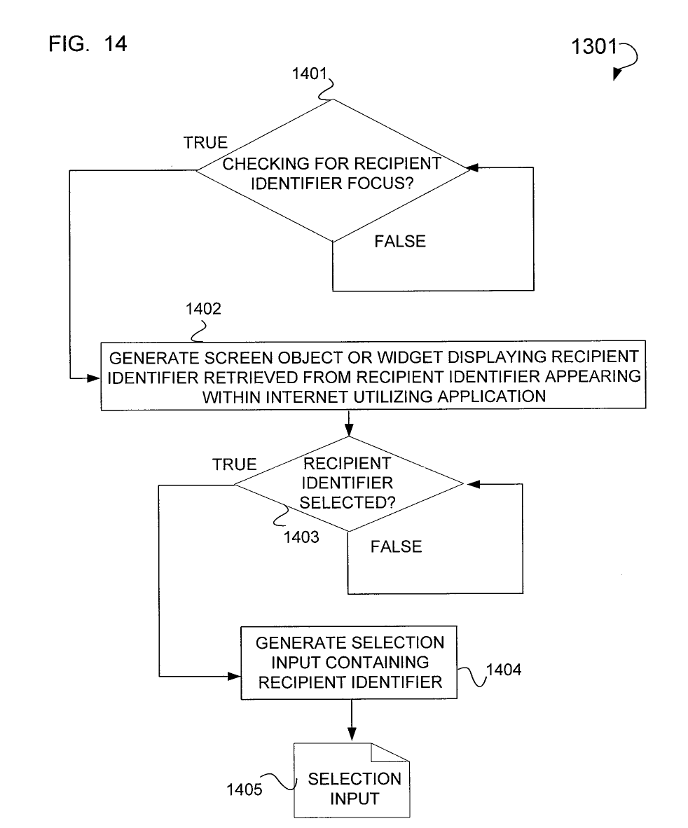

FIG. 14 is a flow chart illustrating an example method used to execute the plug-in engine 1301 used to detect a recipient identifier and to generate a selection input. Shown is a decisional operation 1401 that, when executed, used to check for a recipient identifier focus. In some example embodiments, a mouse pointer is placed into close proximity to a recipient identifier such that the recipient identifier receives the focus of the mouse pointer. In cases where the decisional operation 1401 evaluates to “false,” the decisional operation continues to execute iteratively or recursively seeking to detect whether recipient identifier has received the focus of the mouse pointer. In cases where decisional operation 1401 evaluates to “true,” and the recipient identifier has received the focus of the mouse pointer, an operation 1402 is executed that generates a screen object or widget displaying the recipient identifier. In some example cases, a mouse over operation may be executed as part of the operation 1402. In certain cases, the screen object or widget generated through the execution of operation 1402 may be a drop down menu, scroll down menu, radio button, or other suitable screen object or widget that allows a sender of funds 101 to select a recipient identifier. A decisional operation 1403 may executed to determine whether the recipient identifier that is generated as part of the screen or object or widget has been selected by the sender of funds 101. This decisional operation 1403 is referenced elsewhere as the send money function 204, 303, or 407. In example cases where decisional operation 1403 evaluates to “false,” the decisional operation 1403 continues to execute iteratively or recursively. In example cases, where decisional operation 1403 evaluates to “true,” an operation 1404 may be executed. In one example embodiment, operation 1404, when executed, generates a selection input 1405 containing a recipient identifier. This selection input 1405 may be a recipient identifier encoded as a signal.

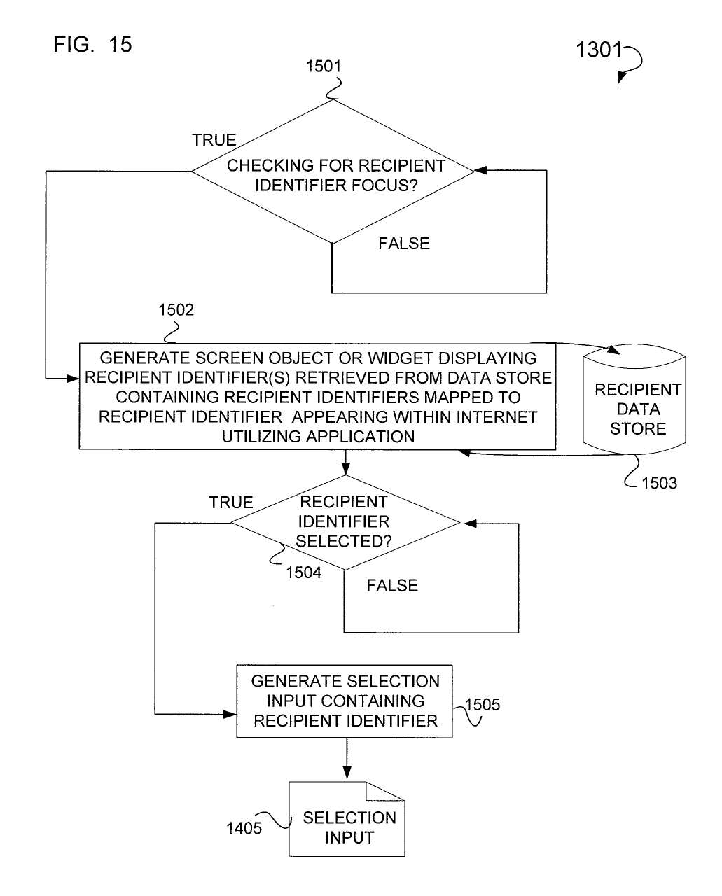

FIG. 15 is a flow chart illustrating an example method used to execute the plug-in engine 1301 used to detect a recipient identifier and to generate a selection input from a plurality of recipient identifiers. Shown is a decisional operation 1501 that, when executed, used to check for a recipient identifier focus. In some example embodiments, a mouse pointer is placed into close proximity to a recipient identifier such that the recipient identifier receives the focus of the mouse pointer. In cases where the decisional operation 1501 evaluates to “false,” the decisional operation continues to execute iteratively or recursively seeking to detect whether recipient identifier has received the focus of the mouse pointer. In cases where decisional operation 1501 evaluates to “true,” and the recipient identifier has received the focus of the mouse pointer, an operation 1502 is executed that generates a screen object or widget displaying the recipient identifier. In some example cases, a mouse over operation may be executed as part of the operation 1502. In certain cases, the screen object or widget generated through the execution of operation 1502 may be a drop down menu, scroll down menu, radio button, or other suitable screen object or widget that allows a sender of funds 101 to select an recipient identifier. In some example embodiments, through the execution of the operation 1502 at least one recipient identifier may be retrieved from a recipient data store 1503. This at least one recipient identifier may then be displayed in a screen object or widget along with other recipient identifiers all mapped to the same recipient identifier receiving the focus of the mouse pointer. A decisional operation 1504 may executed to determine whether the recipient identifier that is generated as part of the screen or object or widget has been selected by the sender of funds 101. This decisional operation 1504 is referenced elsewhere as the send money function 204, 303, or 407. In example cases where decisional operation 1503 evaluates to “false,” the decisional operation 1504 continues to execute iteratively or recursively. In example cases, where decisional operation 1504 evaluates to “true,” an operation 1505 may be executed. In one example embodiment, operation 1505, when executed, generates a selection input 1405 containing a recipient identifier. This selection input 1405 may be a recipient identifier encoded as a signal.

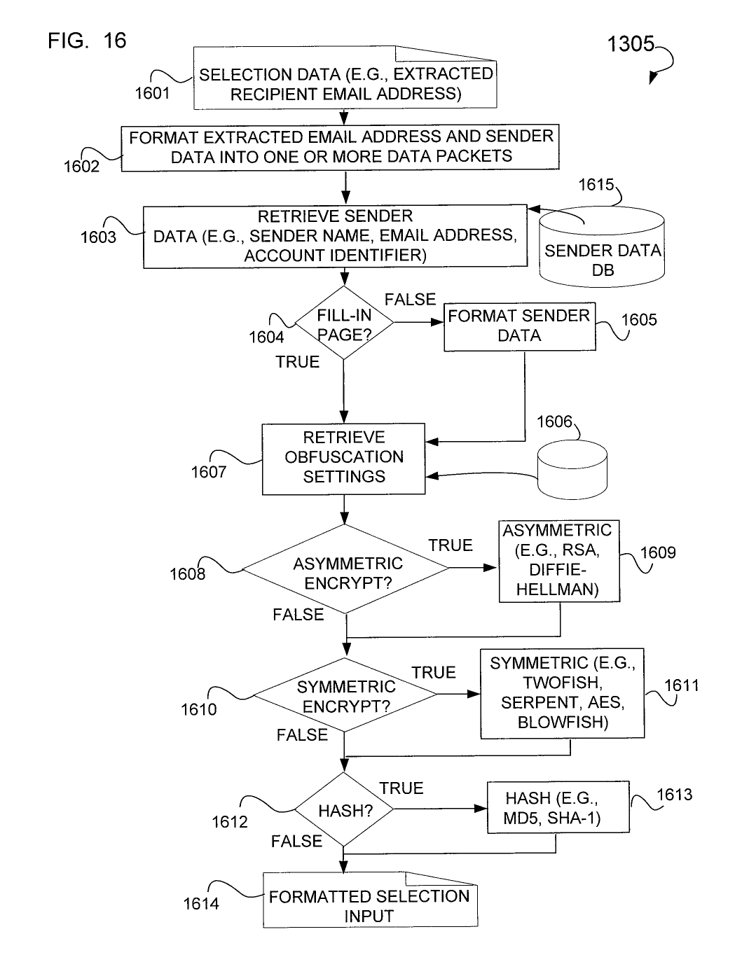

FIG. 16 is a flowchart illustrating an example method used to execute operation 1305. Shown is selection data 1601 such as, for example, an extracted recipient e-mail address. Through the execution of an operation 1602, this selection data 1601 and, for example, the extracted recipient e-mail address contained therein, is formatted along with, in some cases, sender data. Once formatted, this extracted e-mail address and, in certain cases, sender data are placed into one or more data packets. Operation 1603 may act to retrieve sender data such as, for example, a sender name, e-mail address, or account identifier from a sender data database 1615. In certain instances, a decisional operation 1604 may be executed that may act to take the sender data and fill in some type of page or otherwise provide this information to the payment processor server 109. This page may be, for example, a transaction information page 111. In cases where a decisional operation 1604 evaluates to “false,” an operation 1605 may be executed that formats the sender data for further processing.

In example cases where a decisional operation 1604 evaluates to “true,” a further operation 1607 is executed that retrieves obfuscation settings. This operation 1607 may also be executed upon the completion of the execution of the operation 1605. These obfuscation settings may be retrieved from, for example, a database 1606. The obfuscation settings may include settings relating to various types of encryption, hashing, or other suitable types of obfuscation. In certain example instances, a decisional operation 1608 is executed that determines whether or not the sender data is to be symmetrically encrypted. In example cases where a decisional operation 1608 evaluates to “true,” an operation 1609 is executed that asymmetrically encrypts the sender data using some type of public or even private key that uses an asymmetric encryption algorithm such as, for example, Rivest, Shamir and Adleman (RSA), or Diffie-Hellman. In example cases where a decisional operation 1608 evaluates to “false,” a further decisional operation 1610 is executed that determines whether or not the sender data is to be symmetrically encrypted. In example cases where a decisional operation 1610 evaluates to “true,” a further operation 1611 is executed that applies a symmetric encryption algorithm to the sender data. This symmetric encryption algorithm may be, for example, the Twofish algorithm, the Serpent algorithm, the Advanced Encryption Standard (AES) algorithm, or even the Blowfish algorithm, amongst other suitable symmetric encryption algorithms. In cases where a decisional operation 1610 evaluates to “false,” a further decisional operation 1612 is executed that may act to hash the sender data. In cases where a decisional operation 1612 evaluates to “true,” a further operation 1613 is executed that may, for example, hash the sender data using any one of a number of suitable hashing algorithms such as Message-Digest algorithm (MD5), Secure Hash Algorithm (SHA)-1, or some other suitable hashing algorithm. In cases where a decisional operation 1612 evaluates to “false,” a resulting formatted selection input 1614 is generated. In some example embodiments, sender data may be hashed, symmetrically encrypted, asymmetrically encrypted or may be modified using any one of a combination of these obfuscation techniques (e.g., asymmetric encryption, symmetric encryption, and/or hashing).

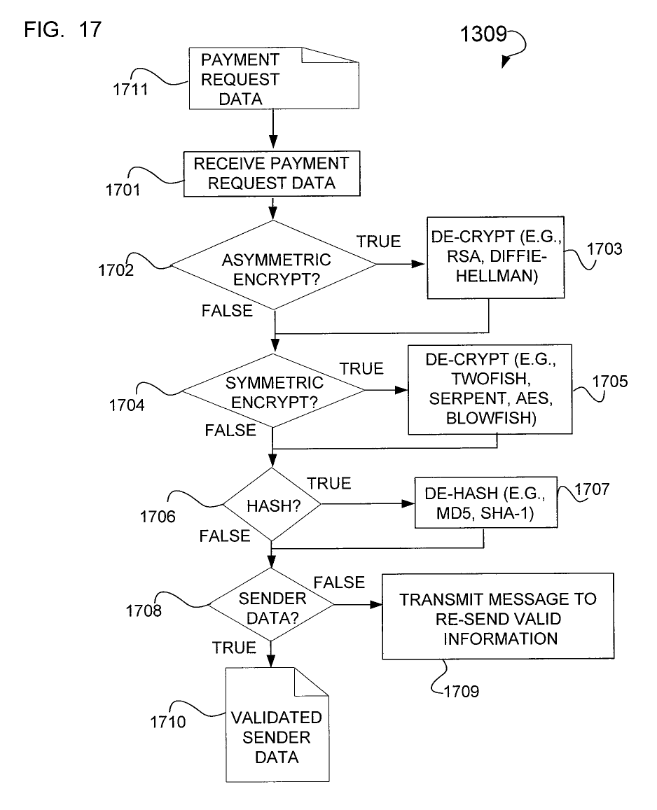

FIG. 17 is a flowchart describing an example method used to execute operation 1309. Shown is payment request data 1711 that is received through the execution of an operation 1701. A decisional operation 1702 may be executed to determine whether or not the payment request data is asymmetrically encrypted. In cases where a decisional operation 1702 evaluates to “true,” an operation 1703 is executed that decrypts the payment request data 1711 using, for example, a private key, or even in some cases, a public key depending upon the particular asymmetric encryption regime. In cases where decisional operation 1702 evaluates to “false,” a further decisional operation 1704 is executed that determines whether or not the payment request data 1711 is symmetrically encrypted. In cases where decisional operation 1704 evaluates to “true,” an operation 1705 is executed that decrypts the payment request data 1711 using any one of a number of symmetrical decryption algorithms including, for example, Twofish, Serpent, AES, the Blowfish algorithm, or some other suitable symmetric encryption algorithm. In cases where decisional operation 1704 evaluates to “false,” a further decisional operation 1706 is executed to determine whether or not the payment request data 1711 has been hashed. In cases where a decisional operation 1706 evaluates to “true,” an operation 1707 is executed that de-hashes the payment request data. This de-hashing may be accomplished through, for example, the MD5 algorithm, the SHA-1, or some other suitable hashing algorithm. In cases where a decisional operation 1706 evaluates to “false,” an operation 1708 is executed that determines whether or not the payment request data 1711 is valid. In cases where a decisional operation 1708 evaluates to “false,” an operation 1709 is executed that transmits a resent message to, for example, the sender of funds 101. In cases where decisional operation 1708 evaluates to “true,” a validated sender data 1710 is generated. In some example embodiments, the process of asymmetrically decrypting, symmetrically decrypting, or de-hashing (e.g., collectively referred to as removing the obfuscation protections) the payment request data 1711 may be done in any one of a number of orders. In some example embodiments, the generation of the validated sender data 1710 may include the passing of the data contained in the payment request data 1711 onto further processes, without its obfuscation protections, to a further operation for processing.

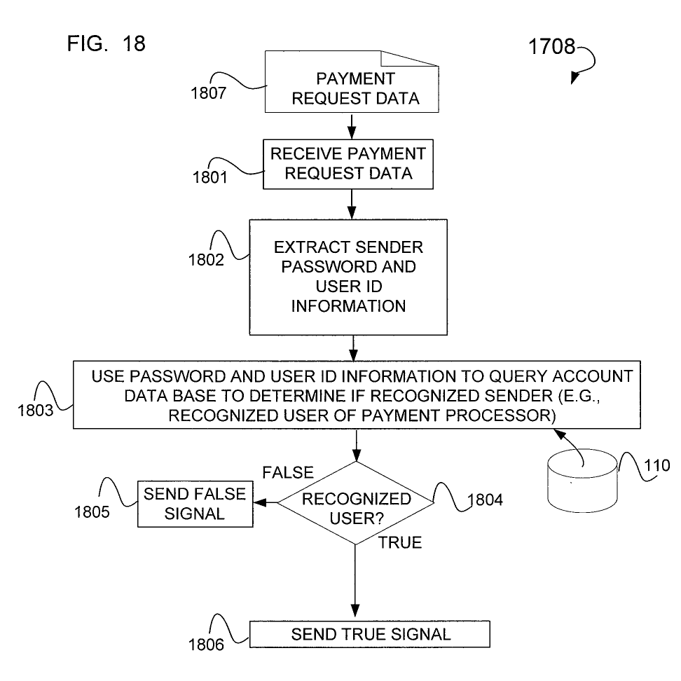

FIG. 18 is a flowchart illustrating an example method used to execute operation 1708. Shown is payment request data 1807 that may be received through the execution of an operation 1801. An operation 1802 may be executed that extracts sender password and user ID information from the payment request data 1807. An operation 1803 may be executed that uses this password and user ID information to query an account database, such as the previously shown account database 110. This query may be performed to determine whether or not the sender of funds, such as the sender funds 101, is a recognized user of the payment processor server 109. A decisional operation 1804 may be executed that determines whether or not the sender of funds is a recognized user. In cases where a decisional operation 1804 evaluates to “false,” an operation 1805 is executed that sends a “false” signal. This “false” signal will later be used to execute the operation 1609. In cases where a decisional operation 1804 evaluates to “true,” an operation 1806 is used or otherwise executed to send a “true” signal. This “true” signal may ultimately be used to generate the validated sender data 1710.

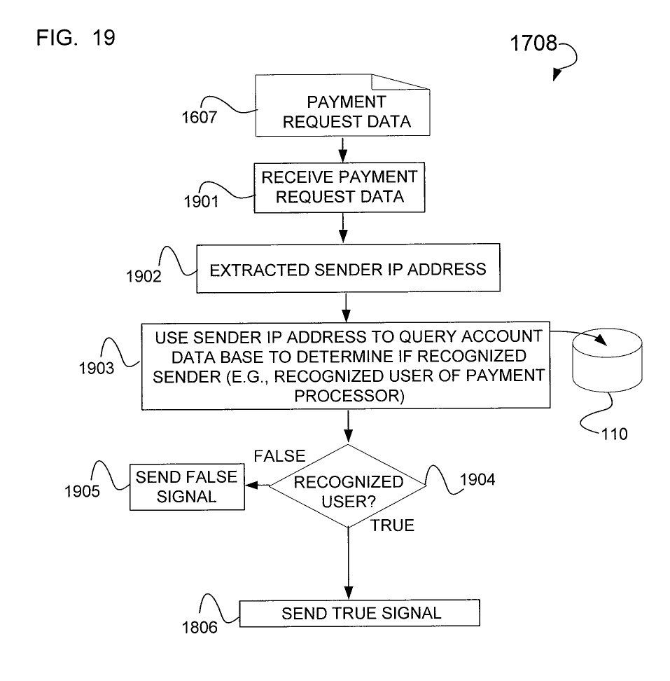

FIG. 19 is a flowchart illustrating an example method used to execute operation 1708. Shown is payment request data 1807 that is received through the execution of an operation 1901. An operation 1902 may be executed that extracts a sender IP address from the payment request data 1807. An operation 1903 may be executed that uses the sender IP address to query an account database, such as account database 110, to determine if the sender is a recognized sender of funds. In some example embodiments, HTTPS, SSL, SSH, Security Assertion Markup Language (SAML), or some other suitable authentication regime may be used to determine if the sender is a recognized sender of funds. An operation 1904 may be executed to determine whether or not the sender of funds is a recognized user. In cases where operation 1904 evaluates to “false,” a further operation 1905 may be executed that sends a “false” signal. This “false” signal may be used to execute the operation 1509. In cases where a decisional operation 1704 evaluates to “true,” a “true” signal may be generated whereby the results of the sending of the “true” signal may be the generation of validated sender data 1710. In some example embodiments, the generation of the validated sender data 1710 may include the passing of the data contained in the payment request data 1711 onto further processes, without its obfuscation protections, to a further operation for processing.

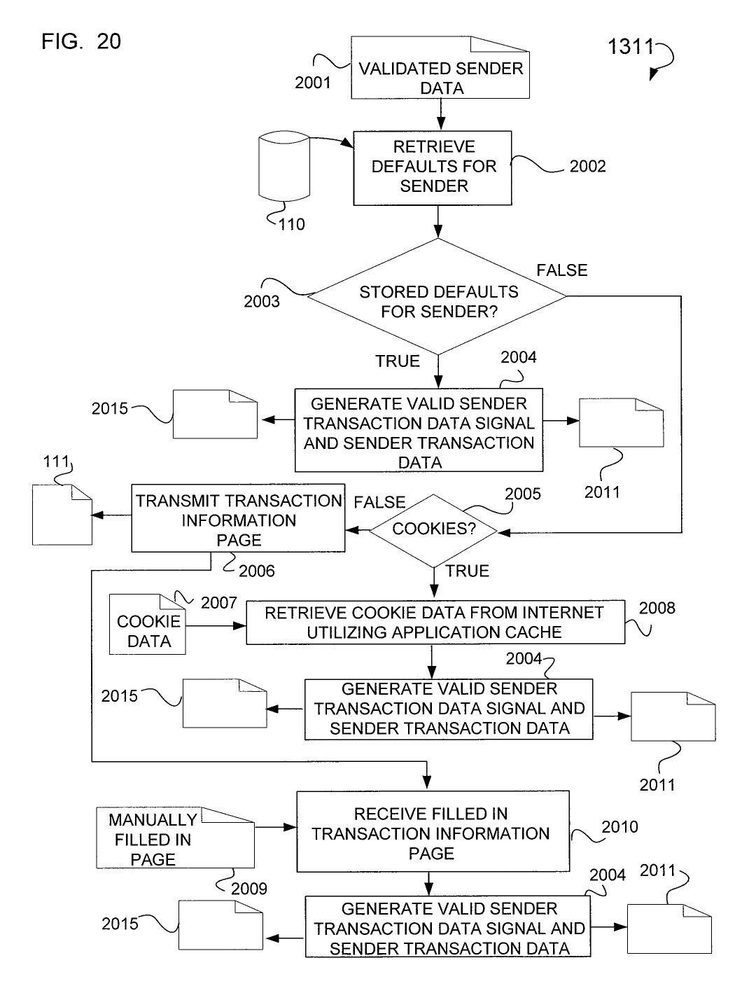

FIG. 20 is a flowchart illustrating an example method used to execute operation 1311. Shown is validated sender data 2001. This validated sender data 2001 may be received through the execution of an operation 2002 that may retrieve certain defaults for a sender from, for example, the account database 110. A decisional operation 2003 is executed that determines whether or not there are stored defaults contained within the account database 110. In cases where a decisional operation 2003 evaluates to “false,” a further decisional operation 2005 may be executed. In example cases where a decisional operation 2003 evaluates to “true,” an operation 2004 is executed that generates a valid sender transaction data signal and sender transaction data. This valid sender transaction data signal may be a valid sender transaction data signal 2015, while the sender transaction data may be sender transaction data 2011.

Decisional operation 2005 may be executed to determine whether or not the Internet-utilizing application 112 used by the sender of funds 101 contains cookie information or other types of digital information in its cache. This cookie information or other type of digital information may be used to provide information regarding the particular transaction that the sender of funds 101 seeks to engage. In example cases where a decisional operation 2005 evaluates to “false,” an operation 2006 is executed that transmits that transaction information page 111 to the sender of funds 101 to be viewed using the Internet-utilizing application 112. In example cases where a decisional operation 2005 evaluates to “true,” a further operation 2008 is executed that retrieves cookie data from the Internet-utilizing application's cache. This cookie data may be, for example, cookie data 2007. In certain example cases, an operation 2004 may be executed that, as previously illustrated, generates valid sender transaction data signal 2015 and sender transaction data 2011. In certain example cases, through the execution of the operation 2006, a further operation 2010 may be executed that receives the filled-in transaction information page 111 from the sender of funds 101. This filled-in transaction information page 111 may be a manually filled-in page 2009. Once this manually filled-in page 2009 is received, then the previously illustrated operation 2004 may be executed.

In some example embodiments, operations 2004, 2006, and 2007 when executed, may utilize HTTPS, SSL, SSH, and other suitable protocols to obscure the data inputted into the transaction information page 111, provided via the valid sender transaction data signal 2015, and sender transaction data 2011. The HTTPS, SSL, SSH, and other suitable protocols may be used in conjunction with a TCP/IP such that a session may be established between, for example, the one or more devices 102 and the payment processor server 109.

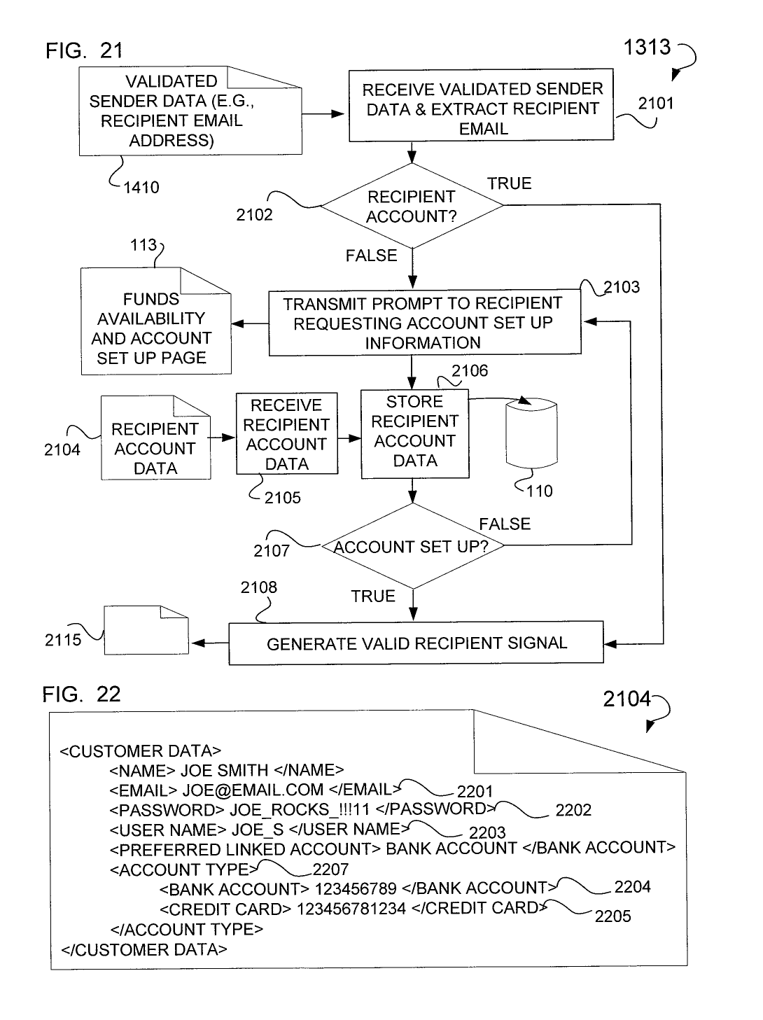

FIG. 21 is a flowchart illustrating an example method used to execute operation 1313. Shown is a validated sender data 1710 that is received through the execution of an operation 2101, where this operation 2101 extracts a recipient e-mail address. A decisional operation 2102 may be executed that determines whether or not the extracted recipient e-mail address corresponds to a particular recipient account or other account that may reside as part of the payment processor server 109. In example cases where a decisional operation 2102 evaluates to “true,” an operation 2108 may be executed that generates a valid recipient signal 2115. In example cases where a decisional operation 2102 evaluates to “false,” an operation 2103 may be executed that transmits a prompt to the recipient requesting account setup information. This prompt may be transmitted as a part of, for example, the previously illustrated funds availability and account setup link 113. An operation 2106 may also be executed along with an operation 2105, wherein the operation 2105 receives recipient account data as a recipient account data packet 2104, then through the execution of the operation 2106 stores this recipient account data into the account database 110. In some example cases, a decisional operation 2107 may be executed to determine whether or not an account has been set up by the recipient of funds 114. In example cases where a decisional operation 2107 evaluates to “false,” the operation 2103 and subsequent operations may be executed. In example cases where a decisional operation 2107 evaluates to “true,” the previously shown operation 2108 may be executed.

FIG. 22 is a diagram of an example recipient account data packet 1904. Shown are a number of fields that may be, for example, a part of the recipient account data packet 1904. These fields include, for example, an e-mail field 2201 containing the e-mail of the recipient of funds 114. Also shown is a password field 2202 containing information relating to a password to be associated with the recipient of funds 114, wherein this password may be used when accessing an account residing as part of the payment processor server 109. Further, shown is a username field 2203 containing a particular user name to be associated with the recipient of funds 114. Also shown is a preferred link account field 2207 that contains at least one linked account, wherein this linked account may contain funds that are to be drawn for satisfaction of payments made using, for example, the payment processor server 109. Further, shown is a bank account field 2204 containing a bank account number corresponding to the linked account as shown in preferred linked account field 2207. Also, a further credit card field 2205 is shown containing credit card information relating to the particular preferred linked account.

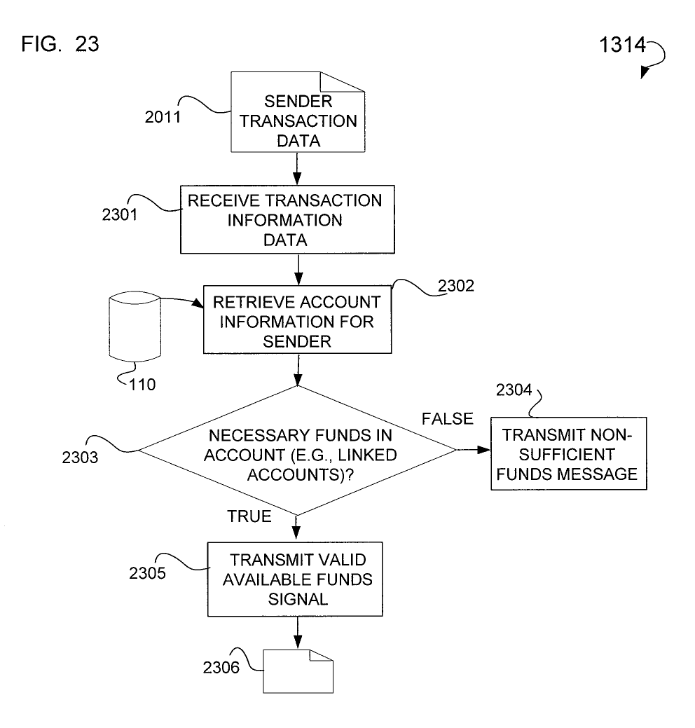

FIG. 23 is a flowchart illustrating an example method used to execute operation 1314. Shown is sender transaction data 1811 that is received through the execution of an operation 2301. An operation 2302 is executed that retrieves account information for a particular sender from an account database 110. A decisional operation 2303 is executed that determines whether there are the necessary funds present in the account or accounts to satisfy the payment request as contained in the sender transaction data 1811. These accounts may be an FI account, and may include checking accounts, credit card accounts, or other suitable accounts. In example cases where a decisional operation 2303 evaluates to “false,” that is there is insufficient funds, an operation 2304 is executed that transmits a non-sufficient finds message to the sender of funds 101. In example cases where a decisional operation 2303 evaluates to “true,” an operation 2305 is executed that transmits a valid available funds signal, such as valid available funds signal 2306.

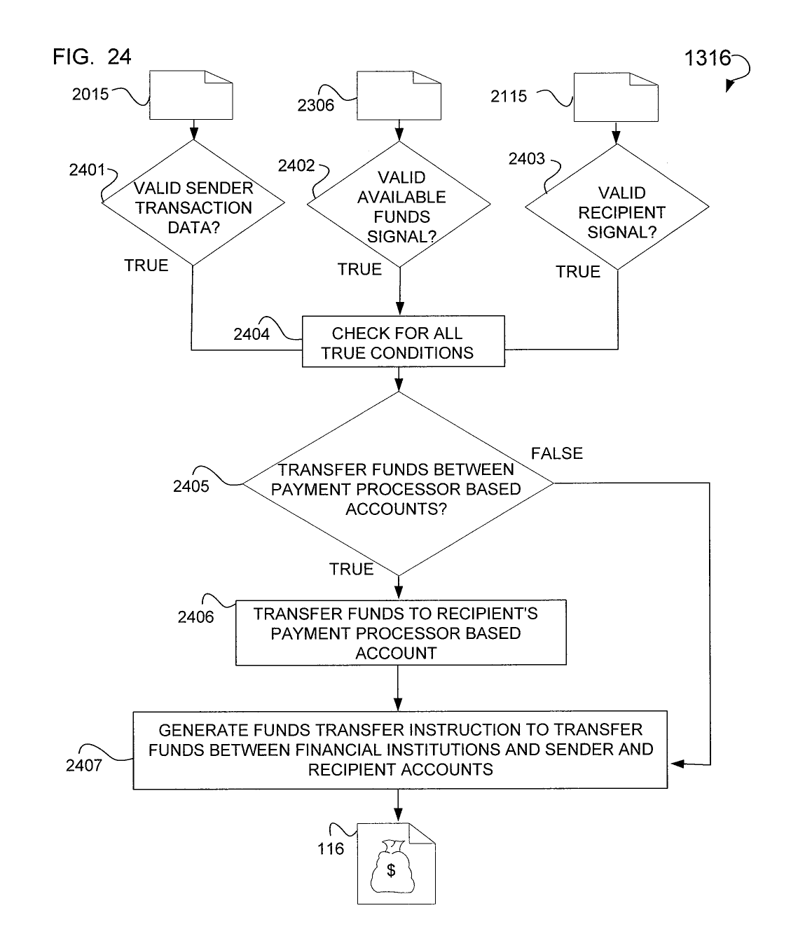

FIG. 24 is a flowchart illustrating an example method used to execute operation 1316. Shown is a valid sender data transaction data signal 2015, a valid available funds signal 2306, and a valid recipient signal 2115. A decisional operation 2401 is shown that, when executed, determines whether or not valid sender transaction data has been provided. Further, a decisional operation 2402 is shown that determines whether a valid available funds signal has been provided. Moreover, a decisional operation 2403 is shown that determines whether or not a valid recipient signal has been provided. In example cases where each of these decisional operations (e.g., decisional operations 2401 through 2403) evaluate to “true,” a further decisional operation 2405 is executed. In the course of determining whether these decisional operations 2401 through 2403 evaluate to “true,” an operation 2404 is executed that checks for a “true” condition being transmitted by each of these decisional operations 2401 through 2403. In example cases where a decisional operation 2405 evaluates to “false,” then payments will be transferred between non-payment processor based accounts which may be, for example, FI based accounts. In such a case where a decisional operation 2405 evaluates to “false,” an operation 2407 may be executed that generates a funds transfer instruction to transfer funds between financial institutions and, more particularly, between sender and recipient held accounts (e.g., an account held by a sender of funds to an account held by a recipient of funds). This funds transfer instruction may be, for example, funds transfer instruction 116. In example cases where a decisional operation 2405 evaluates to “true,” an operation 2406 may be executed that transfers funds to a recipient's payment processor based account.

### Example Storage

Some example embodiments may include the various databases being relational databases, or in some example cases On-Line Analytical Processing (OLAP) based databases. In the case of relational databases, various tables of data are created and data is inserted into, and/or selected from, these tables using a Structured Query Language (SQL) or some other database-query language known in the art. In the case of OLAP databases, one or more multi-dimensional cubes or hypercubes containing multidimensional data from which data is selected from or inserted into using a Multi-Dimensional Expression (MDX) language may be implemented. In the case of a database using tables and SQL, a database application such as, for example, MYSQL™, SQLSERVER™, Oracle 81™, 10G™, or some other suitable database application may be used to manage the data. In this, the case of a database using cubes and MDX, a database using Multidimensional Online Analytic Processing (MOLAP), Relational Online Analytic Processing (ROLAP), Hybrid Online Analytic Processing (HOLAP), or some other suitable database application may be used to manage the data. These tables or cubes made up of tables, in the case of, for example, ROLAP, are organized into a RDS or Object Relational Data Schema (ORDS), as is known in the art. These schemas may be normalized using certain normalization algorithms to avoid abnormalities such as non-additive joins and other problems. Additionally, these normalization algorithms may include Boyce-Codd Normal Form or some other normalization, optimization algorithm known in the art.

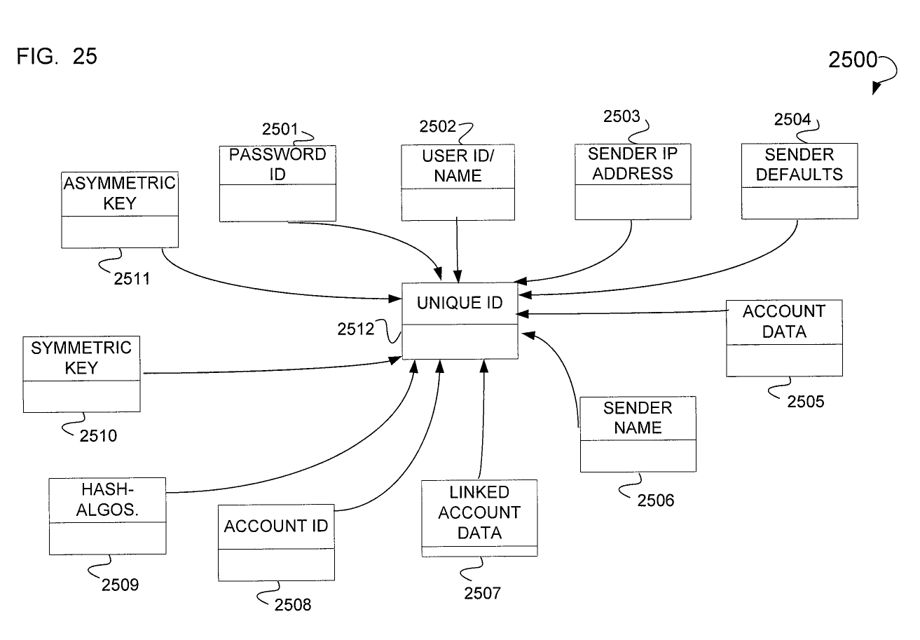

FIG. 25 is an example RDS 2500 that may reside as a part of, for example, an account database 110. Shown is a table 2501 containing password identification information. This password identification information may be, for example, some type of alphanumeric value. It may be stored as, for example, a string or other suitable data type. Also shown is a table 2502 that contains a user ID or name information for a particular account holder or other party that holds an account with the payment processor server 109. This user ID or name information may be, for example, contained as a string data type or other suitable data type. A table 2503 is also shown that contains a sender IP address. This sender IP address may be the previously stated IP address or some other suitable address that may used to determine the sender of funds. This sender IP address may be, for example, a string, float, integer, or some other suitable data type. A table 2504 is also shown that contains various sender defaults. These sender defaults may be default values used for, for example, the sender of funds 101 to send money to a particular recipient. These defaults may include the amount of funds to be sent, the currency type for these sent fund, or other suitable information. A table 2505 is shown that contains account data wherein this account data may be generalized account data relating to, for example, a sender of funds or a recipient of funds and may include, for example, certain types of contact information, such as phone numbers, e-mail addresses, physical addresses, or other data. A string, Character Large Object (CLOB), or some other suitable data type may be used. Further, a table 2506 may be used that contains a particular sender of funds or sender name. A string data type may be used for storing this type of information.

Some example embodiments may include a table 2507 that may be used to contain linked account data. This linked account data may relate to a particular financial institution account or other type of account that serves as the basis for supplying funds to a recipient of funds from a particular sender of funds. This linked account data may be, for example, a string, integer, or some other suitable data type. A table 2508 is also shown that contains an account ID. This account ID may serve to uniquely identify a particular sender of funds, recipient of funds, or other party that holds an account with the payment processor server 109. This account ID may be, for example, a string, integer, or other suitable data type. A table 2509 is also shown that contains various hashing algorithms. These hashing algorithms may be, for example, the previously illustrated SHA-1 algorithm, the MD5 algorithm, or some other suitable hashing algorithm. These hashing algorithms may be stored as, for example, a Binary Large Object (BLOB) or some other suitable data type. A table 2510 is shown that may contain a symmetric key. This symmetric key may be used in the symmetric encrypting or decrypting of particular sender data. A BLOB, integer, or some other suitable data type may be used to store this symmetric key information. A table 2511 is shown that contains asymmetric key information, where this asymmetric key information may be, for example, a private key or a public key. In certain cases, some type of unique identifier identifying the party or individual associated with the private key or public key may be stored within this table 2511. An integer, BLOB, or some other suitable data type may be used to store the symmetric key information into the table 2511. In some example embodiments, a table 2512 containing unique identifier information may be implemented. This unique identifier information may be used to uniquely distinguish a sender of funds or a recipient of funds or some other party holding an account with the payment processor server 109. Further, this unique identifier information, contained in the table 2512, may be used to uniquely identify any one of a number of the data entries stored the tables 2501 through 2511. This unique identifier may be, for example, an integer, float, or some other suitable data type.

### A Three-Tier Architecture

In some example embodiments, a method is illustrated as implemented in a distributed or non-distributed software application designed under a three-tier architecture paradigm, whereby the various components of computer code that implement this method may be categorized as belonging to one or more of these three tiers. Some example embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier, and/or to a backend or storage tier. These logical/mathematical manipulations may relate to certain business rules or processes that govern the software application as a whole. A third storage tier may be a persistent storage medium or non-persistent storage medium. In some example cases, one or more of these tiers may be collapsed into another, resulting in a two-tier architecture or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer-to-peer, or so some other suitable configuration. Further, these three tiers may be distributed between more than one computer system as various software components.

### Component Design

Some example embodiments may include the above illustrated tiers, and the processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language or a different programming language. Various protocols may be implemented to enable these various components to communicate regardless of the programming language used to write these components. For example, a component written in C++ may be able to communicate with another component written in the Java programming language using a distributed computing protocol such as a Common Object Request Broker Architecture (CORBA), a Simple Object Access Protocol (SOAP), or some other suitable protocol. Some example embodiments may include the use of one or more of these protocols with the various protocols outlined in the OSI model, or TCP/IP protocol stack model for defining the protocols used by a network to transmit data.

### A System of Transmission Between a Server and Client

Some example embodiments may use the OSI basic reference model or TCP/IP protocol stack model for defining the protocols used by a network to transmit data. In applying these models, a system of data transmission between a server and client, or between peer computer systems is illustrated as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer and the data transmitted over a network such as the Internet, Local Area Network (LAN), Wide Area Network (WAN), or some other suitable network. In some example cases, Internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology) or structures.

### A Computer System

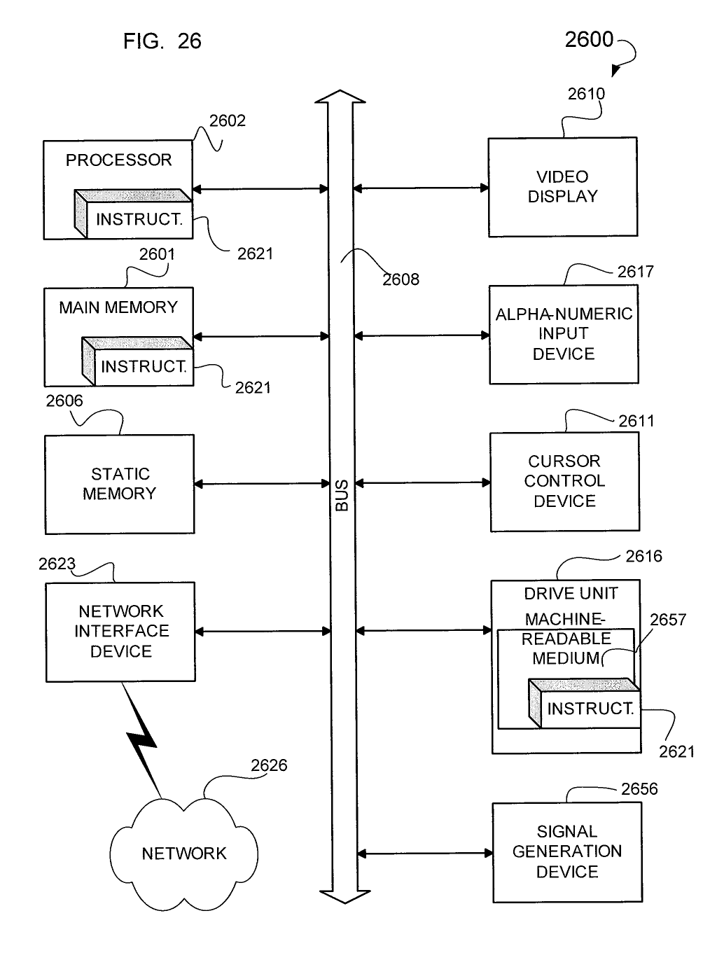

FIG. 26 shows a diagrammatic representation of a machine in the example form of a computer system 2600 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, perform tasks. In a distributed system environment, program modules may be located in both local and remote memory-storage devices (see below).

The example computer system 2600 includes a processor 2602 (e.g., a Central Processing Unit (CPU), a Graphics Processing Unit (GPU) or both), a main memory 2601 and a static memory 2606, which communicate with each other via a bus 2608. The computer system 2600 may further include a video display unit 2610 (e.g., a Liquid Crystal Display (LCD) or a Cathode Ray Tube (CRT)). The computer system 2600 also includes an alphanumeric input device 2617 (e.g., a keyboard), a User Interface (UI) cursor controller 2611 (e.g., a mouse), a disc drive unit 2616, a signal generation device 2656 (e.g., a speaker) and a network interface device (e.g., a transmitter) 2623.

The disc drive unit 2616 includes a machine-readable medium 2657 on which is stored one or more sets of instructions and data structures (e.g., software) embodying or utilized by any one or more of the methodologies or functions illustrated herein. The software may also reside, completely or at least partially, within the main memory 2601 and/or within the processor 2602 during execution thereof by the computer system 2600, the main memory 2601 and the processor 2602 also constituting machine-readable media.

The instructions 2621 may further be transmitted or received over a network 2626 via the network interface device 2623 using any one of a number of well-known transfer protocols (e.g., Hyper Text Transfer Protocol (HTTP), Session Initiation Protocol (SIP)).

In some example embodiments, a removable physical storage medium is shown to be a single medium, and the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

### Marketplace Applications

In some example embodiments, a system and method is shown that allows an individual to select a recipient e-mail address for the purpose of sending money to the recipient. In some respects e-mail addresses have supplanted physical addresses as a location to receive mail. Where physical payment instruments (e.g., checks) in the past may have been sent to a physical address for satisfaction of a debt, various payment processors now allow for e-mail addresses to serve as the basis to receive payments. Through using the system and method illustrated herein, e-mail addresses can be selected to receive monetary payments.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method comprising:
receiving an email address selection displayed as part of a screen widget, the screen widget included within the display of an interface associated with an Internet-utilizing application;
executing a plug in having a send money function, the plug in associated with the Internet-utilizing application, the send money function executed due, in part, to a signal received from an input device; and
generating a payment request identifying a recipient of funds by the e-mail address selection.

2. The computer implemented method of claim 1, further comprising generating transaction information relating to a sender of funds, wherein the transaction information includes at least one of an amount of currency, a currency type, a payment purpose description, a linked account identifier, and a payment message.

3. The computer implemented method of claim 2, wherein the transaction information is stored in a cookie.

4. The computer implemented method of claim 1, further comprising obscuring the payment request using at least one of a symmetric encryption algorithm, an asymmetric encryption algorithm, or a hashing algorithm.

5. A computer implemented method comprising:
receiving an e-mail address displayed in an interface associated with an Internet-utilizing application using an input device;
executing a plug-in engine, associated with the Internet-utilizing application, with a send money function; and
generating, with the send money function, a payment request identifying a recipient of funds with the e-mail address.

6. The computer implemented method of claim 5, wherein the input device is a mouse.

7. The computer implemented method of claim 5, wherein the Internet-utilizing application includes at least one of a Web browser or e-mail client.

8. The computer implemented method of claim 5, further comprising selecting the send money function using a right-click function associated with a mouse.

9. The computer implemented method of claim 5, further comprising obscuring the payment request using an algorithm including at least one of a symmetric encryption algorithm, an asymmetric encryption algorithm, or a hashing algorithm.

10. The computer implemented method of claim 5, further comprising requesting a transaction information page that includes at least one of an amount of currency, a currency type, a payment purpose description, a linked account identifier, or a payment message.

11. A computer system comprising:
a receiver to receive a payment request identifying a recipient of funds by an e-mail address, the payment request generated through the use of a screen widget, associated with an Internet-utilizing application, that contains a recipient identifier;
a first determiner engine to determine whether the recipient of funds has an account and a sender of funds has an account;
a second determiner engine to determine whether funds exist in the sender of funds account to cover a payment request amount; and
a transfer engine to transfer funds to a recipient of funds account, where the sender of funds has funds to transfer that cover the payment request amount.

12. The computer system of claim 11, wherein the account is a payment processor account.

13. The computer system of claim 11, wherein transferring funds occurs where valid sender transaction data, valid available funds data, and a valid recipient signal are provided.

14. The computer system of claim 11, further comprising a transaction request engine to request transaction information from the sender of funds, wherein the requested transaction information includes at least one of an amount of currency, a currency type, a payment purpose description, a linked account identifier, or a payment message.

15. The computer system of claim 14, wherein the transaction information is stored in a cookie.

16. The computer system of claim 11, further comprising a de-obscuring engine to de-obscure the payment request using at least one of a symmetric encryption algorithm, an asymmetric encryption algorithm, or a hashing algorithm.

17. A computer system comprising:
a selector to allow a selection of an e-mail address, displayed within a screen widget, included within the display of an interface associated with an Internet-utilizing application;
a plug in to execute a send money function associated with the Internet-utilizing application, the send money function executed due, in part, to a signal from an input device; and
a payment engine to generate a payment request identifying a recipient of funds by the e-mail address.

18. The computer system of claim 17, wherein the input device is a mouse.

19. The computer system of claim 17, wherein the Internet-utilizing application includes at least one of a Web browser or e-mail client.

20. The computer system of claim 17, wherein the selector that selects the send money function is performed using a right-click function associated with a mouse.

21. The computer system of claim 17, further comprising an obscuring engine that obscures the payment request using at least one of a symmetric encryption algorithm, an asymmetric encryption algorithm, or a hashing algorithm.

22. The computer system of claim 17, further comprising a request engine to request a transaction information page used to designate at least one of an amount of currency, a currency type, a payment purpose description, a linked account identifier, and a payment message.

23. A machine-readable medium comprising instructions, which when implemented by one or more machines cause the one or more machines to perform the following operations:
receiving a payment request identifying a recipient of funds by an e-mail address, the payment request generated, in part, using a recipient identifier as displayed by a screen widget as part of an Internet-utilizing application;
determining whether the recipient of funds has an account, and a sender of funds has an account;
determining whether funds exist in the sender of funds account to cover a payment request amount; and
transferring funds to a recipient of funds account, where the sender of funds has funds to transfer that cover the payment request amount.
